(19) United States
(12) Patent Application Publication
(10) Pub. No.: US 2003/0183741 A1
(43) Pub. Date: Oct. 2, 2003

(54) Support pad system

(76) Inventor: Mauric Frank Milner, Crowley, TX (US)

Correspondence Address: Michael S. Neustel, Suite No. 4, 2534 South University Drive, Fargo, ND, 58103, US

(21) Appl. No.: 10/113,331

(22) Filed: Mar. 28, 2002

(51) Int. Cl. F16M 1/00

(52) U.S. Cl. 248/679

(57) ABSTRACT

A support pad system that is lightweight, flexible and economical to produce. The support pad system includes a polystyrene block having an upper surface, a sidewall, and a bottom surface. A first layer is applied to the outer surface of the polystyrene block. A reinforcing sheet is then applied to the upper surface, the sidewall and a portion of the bottom surface of the polystyrene block while the first layer remains in liquid form. A second layer is then applied to the reinforcing sheet and the polystyrene block. The first layer and the second layer are each comprised of cement, sand and a polymer solution. The reinforcing sheet is comprised of a woven or non-woven material.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to equipment support pads and more specifically it relates to an equipment support pad system that is lightweight, flexible and economical to produce.

2.Description of the Prior Art

Equipment support pads have been in use for years for supporting heavy equipment such as air conditioner condensers, swimming pool pumps and other heavy equipment requiring a support pad. Conventional equipment support pads are comprised of a slab of concrete or a piece of metal to support the equipment. Recently, reinforced plastic support pads have been manufactured in an attempt to reduce weight and cost compared to concrete and metal support pads.

Conventional concrete support pads are heavy to utilize requiring significant amounts of time and labor to install along with machinery. In addition, concrete support pads are expensive to manufacture. Another problem with conventional concrete support pads is that they are susceptible to cracking and breakage over periods of time. Conventional metal support pads are also heavy and also expensive to manufacture because of the materials utilized. A common problem with conventional concrete and metal support pads is that shipping the support pads is relatively expensive because of the significant weight of the support pads. Plastic support pads are lightweight and inexpensive, however plastic support pads do not have the strength to withstand extended usage thereof in various types of environments.

Examples of patented devices which are related to the present invention include U.S. Pat. No. 4,505,449 to Turner et al.; U.S. Pat. No. 5,728,458 to Sweeney; U.S. Pat. No. 5,333,830 to Millen; U.S. Pat. No. 4,946,725 to Harlan; U.S. Pat. No. 6,050,539 to Millen; U.S. Pat. No. 5,950,980 to Folmar; U.S. Pat. No. 3,722,845 to Unger; U.S. Pat. No. 5,961,093 to Jones et al.; and U.S. Pat. No. 5,268,226 to Sweeney.

While these devices may be suitable for the particular purpose to which they address, they are not as lightweight, flexible and economical to produce as the present invention. Conventional support pads are expensive to manufacture, expensive to ship, difficult to install, prone to breakage and not economical to produce.

In these respects, the support pad system according to the present invention substantially departs from the conventional concepts and designs of the prior art, and in so doing provides an apparatus that is lightweight, flexible and economical to produce.

### SUMMARY OF THE INVENTION

In view of the foregoing disadvantages inherent in the known types of equipment support pads now present in the prior art, the present invention provides a new support pad system construction that is lightweight, flexible and economical to produce.

The general purpose of the present invention, which will be described subsequently in greater detail, is to provide a new support pad system that has many of the advantages of the equipment support pads mentioned heretofore and many novel features that result in a new support pad system which is not anticipated, rendered obvious, suggested, or even implied by any of the prior art equipment support pads, either alone or in any combination thereof.

To attain this, the present invention generally comprises a polystyrene block having an upper surface, a sidewall, and a bottom surface. A first layer is applied to the outer surface of the polystyrene block. A reinforcing sheet is then applied to the upper surface, the sidewall and a portion of the bottom surface of the polystyrene block while the first layer remains in liquid form. A second layer is then applied to the reinforcing sheet and the polystyrene block. The first layer and the second layer are each comprised of cement, sand and a polymer solution. The reinforcing sheet is comprised of a woven or non-woven material.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a support pad system that will overcome the shortcomings of the prior art devices.

A second object is to provide a support pad system that is lightweight, flexible and economical to produce.

Another object is to provide a support pad system that is not prone to breakage.

An additional object is to provide a support pad system that adequately supports equipment from sinking into the ground surface.

A further object is to provide a support pad system that are easy to handle, manipulate, and install thereby reducing injuries to installers.

Another object is to provide a support pad system that reduces the amount of time required to install an equipment support pad.

A further object is to provide a support pad system that is capable of supporting various sizes and weights of equipment and various other objects.

Another object is to provide a support pad system that reduces the overall weight placed upon the ground surface thereby reducing the amount of sinking of the support pad within the ground surface.

Another object is to provide a support pad system that is not susceptible to damage from lawn care equipment such as grass trimmers and debris thrown by such equipment.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the polystyrene block.

FIG. 2 is an upper perspective view of the polystyrene block with the corners rounded.

FIG. 3 is an upper perspective view of the first layer applied to the polystyrene block.

FIG. 4 is an upper perspective view of the reinforcing sheet being applied to the polystyrene block.

FIG. 5 is an upper perspective view of the reinforcing sheet attached to the polystyrene block.

FIG. 6 is a bottom view of the polystyrene block with the reinforcing sheet attached thereto.

FIG. 7 is a cross sectional view taken along line 7-7 of FIG. 6.

FIG. 8 is an upper perspective view of the second layer applied to the polystyrene block and the reinforcing sheet.

FIG. 9 is a cross sectional view taken along line 9-9 of FIG. 8.

FIG. 10 is a flowchart illustrating the manufacturing of the present invention.

### DESCRIPTION OF THE PREFERRED EMBODIMENT

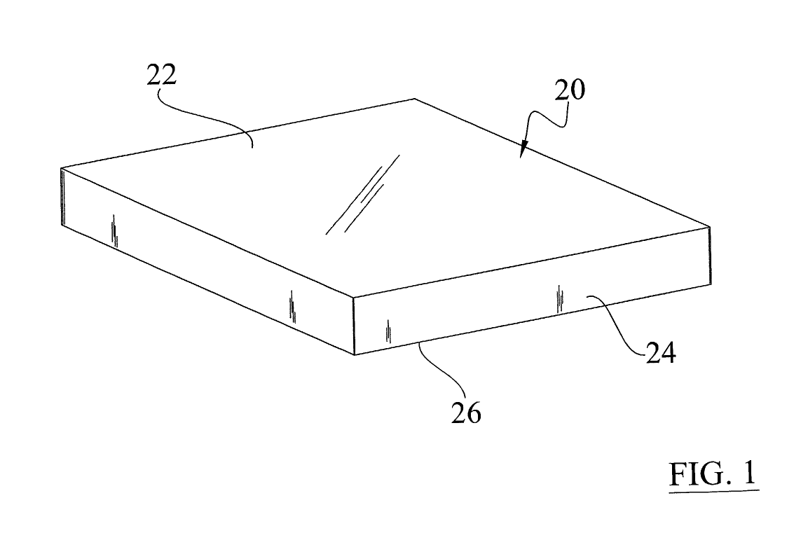

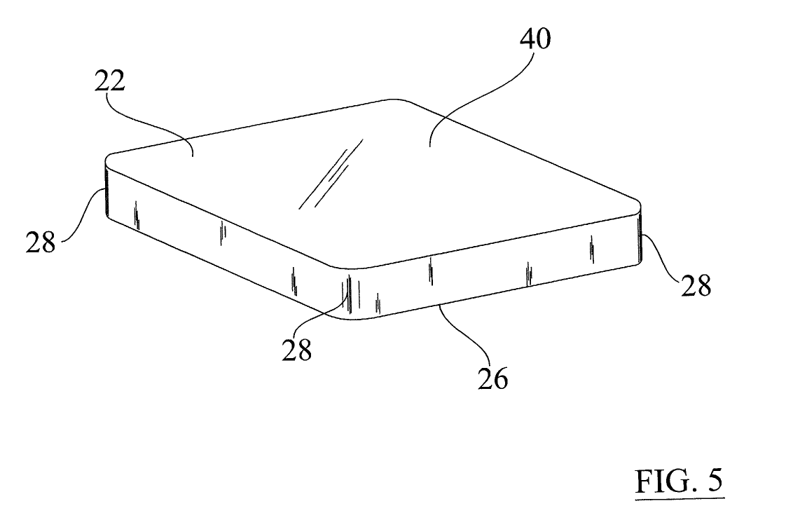

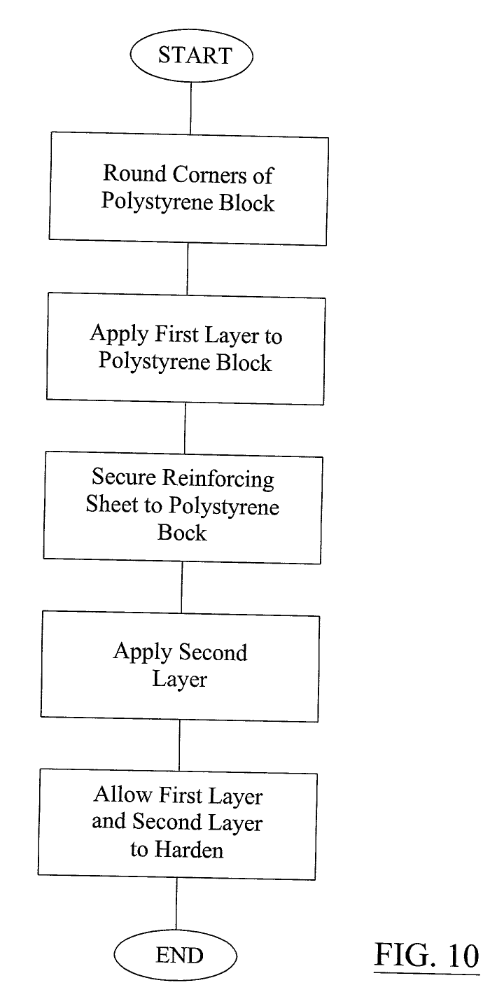

Turning now descriptively to the drawings, in which similar reference characters denote similar elements throughout the several views, FIGS. 1 through 10 illustrate a support pad system 10, which comprises a polystyrene block 20 having an upper surface 22, a sidewall 24, and a bottom surface 26. A first layer 30 is applied to the outer surface of the polystyrene block 20. A reinforcing sheet 40 is then applied to the upper surface 22, the sidewall 24 and a portion of the bottom surface 26 of the polystyrene block 20 while the first layer 30 remains in liquid form. A second layer 50 is then applied to the reinforcing sheet 40 and the polystyrene block 20. The first layer 30 and the second layer 50 are each comprised of cement, sand and a polymer solution. The reinforcing sheet 40 is comprised of a woven or non-woven material.

As shown in FIG. 1, the polystyrene block 20 is comprised of a generally square structure having a generally uniform thickness. The polystyrene block 20 has an upper surface 22, a bottom surface 26 opposite of the upper surface 22 and at least one sidewall 24. The upper surface 22 and the bottom surface 26 are preferably comprised of a flat structure to support an object evenly upon a ground surface. FIG. 1 illustrates the polystyrene block 20 having a four-cornered structure having four sidewalls 24. Polystyrene provides a strong and lightweight material to form the block 20. However, various other similar materials may be utilized to construct the block 20.

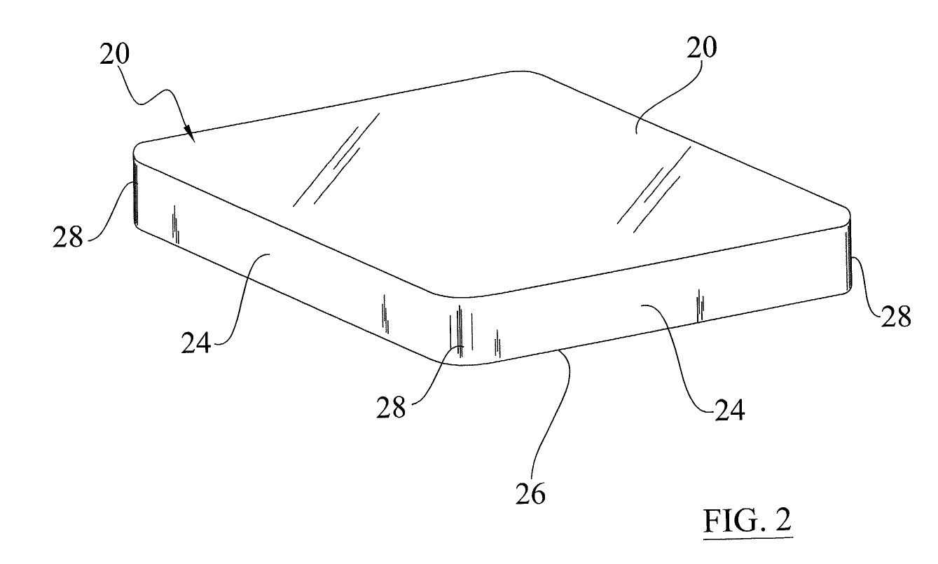

As shown in FIG. 2, the corners 28 of the polystyrene block 20 are preferably rounded utilizing conventional tools. The corners 28 may be a curved structure or formed into a plurality of angled sections. The rounded corners 28 increase the overall strength of the structure and reduce the likelihood of damage to the support pad system 10 while supporting an object.

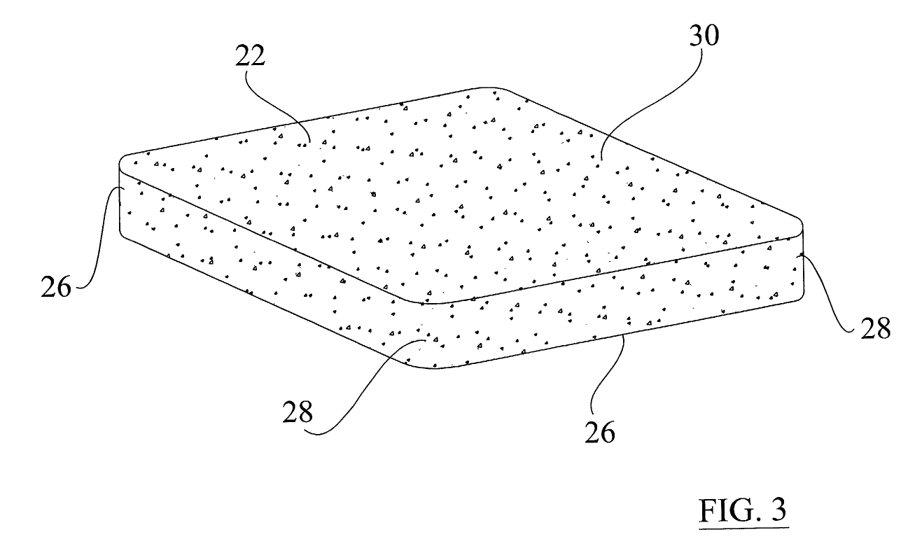

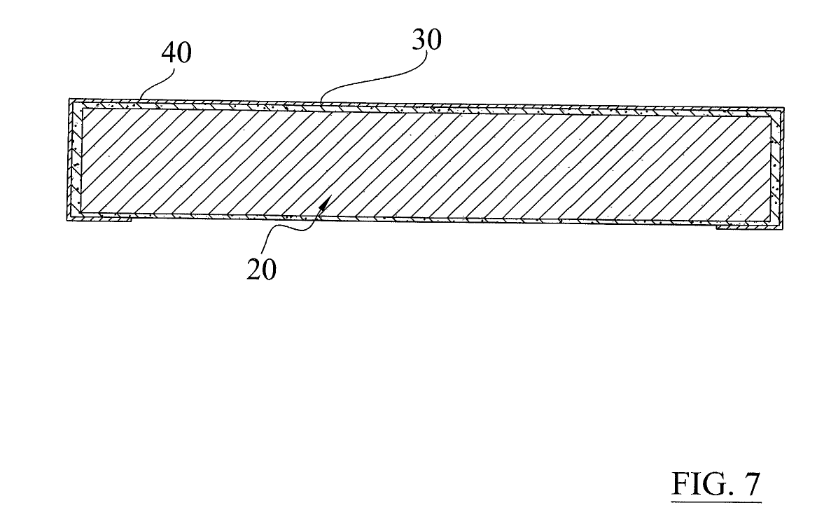

FIG. 3 illustrates the application of a first layer 30 to the outer surface of the polystyrene block 20. The first layer 30 is preferably applied to the upper surface 22, the sidewall 24 and part of the bottom surface 26 to either completely cover the entire outer surface of the polystyrene block 20 or only where the reinforcing sheet 40 will be applied. The first layer 30 may be applied to the polystyrene block 20 utilizing various methods such as but not limited to spraying, pouring or spreading with trowel, brush or other tool. As shown in FIG. 7 of the drawings, the thickness of the first layer 30 adjacent the sidewall 24 is preferably greater than the thickness of the first layer 30 adjacent the upper surface 22 and the bottom surface 26 for added protection against damage from lawn care equipment.

The first layer 30 is preferably comprised of a liquid composition of a volume of cement, a volume sand, a volume of acrylic based additive and a volume of water. The acrylic based additive is comprised of any acrylic polymer based additive commonly utilized within the concrete industry to waterproof concrete, and add flexibility and strength. The acrylic based additive may also be comprised of any acrylic polymer based finish coats commonly utilized within the stucco industry to protect the outer layer of the stucco.

The composition of the first layer 30 is preferably comprised of approximately 1 quart of acrylic based additive, approximately 3 quarts (approximately 10 pounds) of cement, approximately 7 quarts of brick sand, and approximately 1 quart of water. Additionally, a thinning solution comprised of approximately 50% water and approximately 50% acrylic additive may be added to the composition until the desired consistency is achieved. The components of the first layer 30 are thoroughly mixed together prior to applying to the polystyrene block 20. For example, if the first layer 30 is to be applied with a spray tool, additional 50% water and 50% acrylic additive mixture is added to thin the composition. It can be appreciated that varying amounts of each of the components may be utilized to create the first layer 30. The volume of acrylic based additive may range between 5%-20% of the total first layer composition volume. The volume of cement may range between 20%-40% of the total first layer composition volume. The volume of sand may range between 35% to 75% of the total first layer composition volume. The volume of water may range between 0%-10% of the total first layer composition volume.

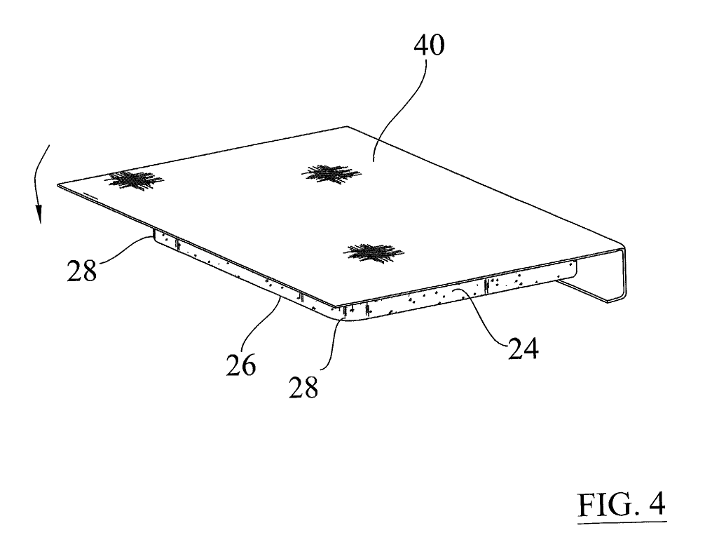

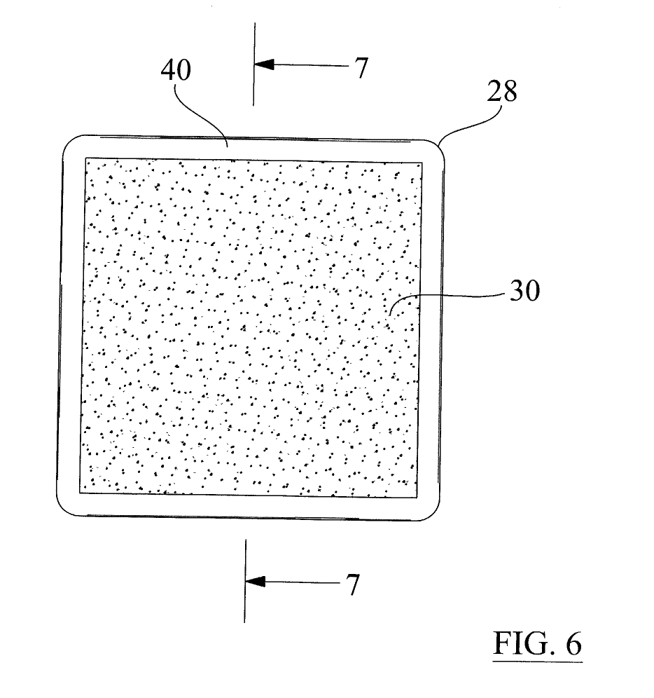

After the first layer 30 is applied to the polystyrene block 20, a reinforcing sheet 40 is secured about the upper surface 22, the sidewall 24 and at least a portion of the bottom surface 26 as shown in FIGS. 4, 5, 6, 7 and 10 of the drawings. The reinforcing sheet 40 is preferably wrapped about the perimeter edges of the bottom portion inwardly a finite distance as shown in FIG. 6 of the drawings. However, the reinforcing sheet 40 may be extended about the entire bottom surface 26 if desired. The reinforcing sheet 40 is secured to the polystyrene block 20 by the first layer 30 acting as an adhesive until hardening thereof.

The reinforcing sheet 40 may have various sizes, thickness and shapes suitable for covering the polystyrene block 20. The reinforcing sheet 40 is preferably comprised of a material resistant to breakage and cutting such as but not limited to polypropylene, fiberglass or other similar material. The reinforcing sheet 40 may be comprised various types of textiles such as but not limited to a woven, non-woven or mesh fabric. It can be appreciated that the reinforcing sheet 40 may be “pre-soaked” within the solution of first layer 30 prior to applying to the polystyrene block 20 instead of applying the first layer 30 to the block 20 directly. Also, if the user is utilizing a porous material for the reinforcing sheet 40, the first layer 30 may simply be directly applied to the reinforcing sheet 40 attached to the polystyrene block 20 thereby eliminating the need for the second layer 50 to be applied. In addition, metal strips or other rigid members may be attached about the sidewall 24 of the block 20 and the reinforcing sheet 40.

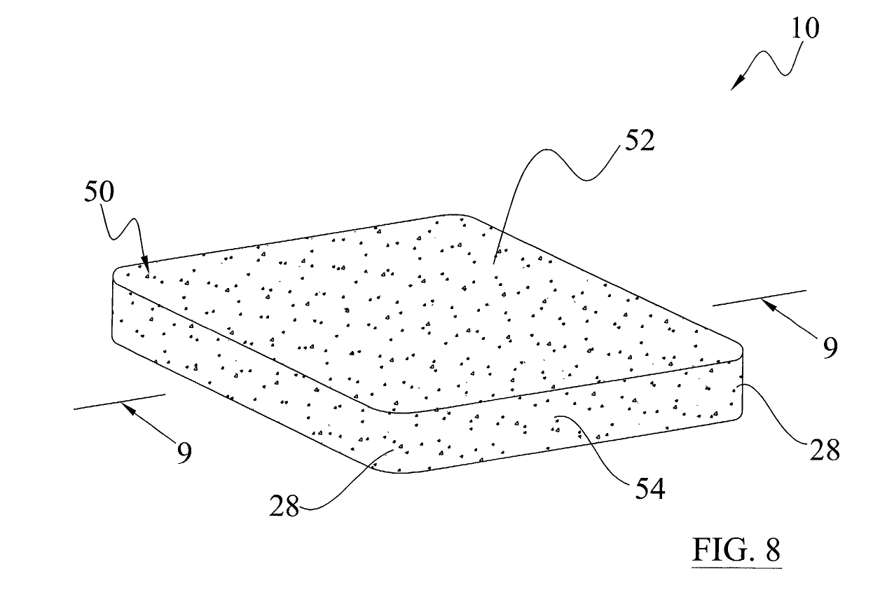

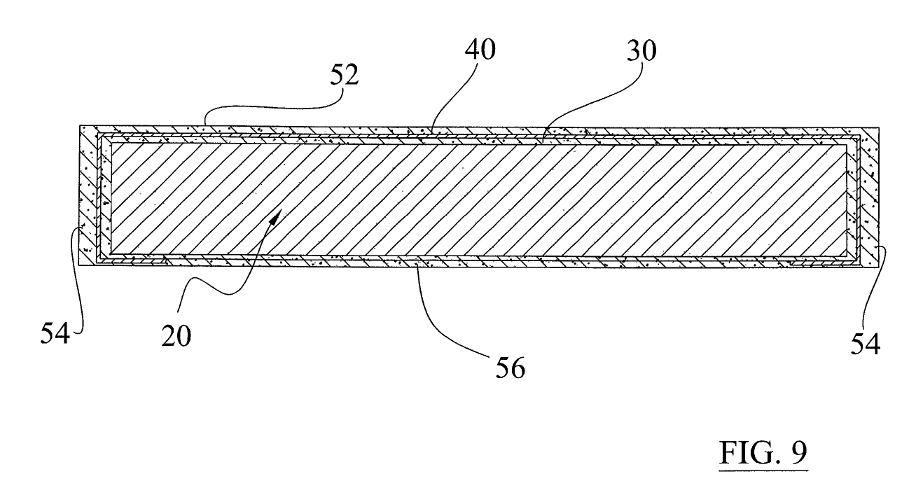

After the reinforcing sheet 40 is secured to the polystyrene block 20, the user then applies the second layer 50 about the reinforcing sheet 40 as shown in FIG. 8 of the drawings. The second layer 50 is comprised of a similar or identical composition as the first layer 30. The second layer 50 has an upper layer 50 adjacent the upper surface 22, a side layer 54 adjacent the sidewall 24 and a bottom layer 56 adjacent the bottom surface 26 of the polystyrene block 20. As shown in FIG. 9 of the drawings, the thickness of the side layer 54 is preferably greater than the thickness of the upper layer 50 and the bottom layer 56 because of the increased wear incurred thereto.

The thickness of the upper layer 50 is preferably greater than the thickness of the bottom layer 56 to allow for supporting a heavy object, but to allow a more flexible bottom layer 56 to conform to the ground more readily and make installation easier. However, it can be appreciated by one skilled in the art that other embodiments of the present invention may include bottom layers 56, side layers 54 and upper layers 50 of various thicknesses relative to each other, to include leaving the bottom surface 26 without a bottom layer 56.

The combination of the first layer 30, the reinforcing sheet 40 and the second layer 50 are then allowed to harden into a relatively lightweight and strong structure capable of supporting a heavy object and resisting damage caused by lawn maintenance equipment. Processes may be employed to encourage the hardening of the first layer 30 and the second layer 50 such as the usage heat or air movement.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A support pad system, comprising:
a block member having an upper surface, a sidewall and a bottom surface;
a first layer covering at least said upper surface and said sidewall of said block member;
a reinforcing sheet secured to said first layer; and
a second layer covering said reinforcing sheet.

2. The support pad system of claim 1, wherein said second layer is comprised of an upper layer, a side layer and a bottom layer, wherein said side layer and said upper layer are thicker than said bottom layer.

3. The support pad system of claim 1, wherein said first layer is comprised of a volume of acrylic based additive, a volume of cement, a volume of sand and a volume of water.

4. The support pad system of claim 3, wherein said volume of acrylic based additive is 5%-20% of said first layer.

5. The support pad system of claim 3, wherein said volume of cement is 20%-40% of said first layer.

6. The support pad system of claim 3, wherein said volume of sand is 35%-75% of said first layer.

7. The support pad system of claim 3, wherein said volume of water is 0%-10% of said first layer.

8. The support pad system of claim 7, wherein said first layer and said second layer are comprised of:
(a) approximately 1 quart of acrylic based additive;
(b) approximately 3 quarts of cement;
(c) approximately 7 quarts of brick sand; and
(d) approximately 1 quart of water.

9. The support pad system of claim 1, wherein said block member includes a plurality of rounded corners.

10. The support pad system of claim 1, wherein said reinforcing sheet extends about said upper surface, said sidewall and an outer perimeter portion of said bottom surface of said block member.

11. The support pad system of claim 1, wherein said block member is comprised of polystyrene.

12. The support pad system of claim 1, wherein said reinforcing sheet is comprised of a textile.

13. The support pad system of claim 1, wherein said reinforcing sheet is comprised of a non-woven textile.

14. A method of manufacturing a support pad, comprising the steps of:
(a) applying a first layer to an upper surface and a sidewall of a block member;
(b) securing a reinforcing sheet to said upper surface and said sidewall of said block member;
(c) applying a second layer to said reinforcing sheet; and
(d) allowing said first layer and said second layer to dry.

15. The method of manufacturing a support pad of claim 14, wherein said first layer is comprised of a volume of acrylic based additive, a volume of cement, a volume of sand and a volume of water.

16. The method of manufacturing a support pad of claim 15, wherein said volume of acrylic based additive is 5%-20% of said first layer.

17. The method of manufacturing a support pad of claim 15, wherein said volume of cement is 20%-40% of said first layer.

18. The method of manufacturing a support pad of claim 15, wherein said volume of sand is 35%-75% of said first layer.

19. The method of manufacturing a support pad of claim 15, wherein said first layer and said second layer are comprised of:
(a) approximately 1 quart of acrylic based additive;
(b) approximately 3 quarts of cement;
(c) approximately 7 quarts of brick sand; and
(d) approximately 1 quart of water.

20. A method of manufacturing a support pad, comprising the steps of:
(a) providing a block member having an upper surface, a sidewall and a bottom surface;
(b) positioning a reinforcing sheet adjacent to said upper surface and said sidewall of said block member;
(c) applying a composition to said reinforcing sheet, wherein said composition is comprised of acrylic based additive, cement, sand and water; and
(d) allowing said composition to dry.
